(19) United States
(12) Patent Application Publication
(10) Pub. No.: US 2007/0059988 A1
(43) Pub. Date: Mar. 15, 2007

(54) Electrical circuit board and a multiconnector

(76) Inventor: Masud Bolouri-Saransar, Naerum (DK)

Correspondence Address: LADAS & PARRY, 26 WEST 61ST STREET, NEW YORK, NY, 10023, US

(21) Appl. No.: 10/168,606

(22) PCT Filed: Dec. 29, 2000
(86) PCT No.: PCT/DK00/00739

§ 371 Date: Oct. 10, 2006

(30) Foreign Application Priority Data
Dec. 30, 1999 (DK) PA199001876

(51) Int. Cl. H01R 24/00

(52) U.S. Cl. 439/676

(57) ABSTRACT

An electrical circuit board and multiconnector having protruding contact pins, which together form contact areas for providing contact with a complementary connector, are arranged such that the contact pins (6-13) extend out from one of the sides of the circuit board (1) substantially in a direction K which corresponds to the direction of coupling of a multiconnector and a complementary connector.

The invention relates to an electrical circuit board having protruding contact pins which together form the contact area in a male connector or in a corresponding female connector, so that an electrical multiconnector connection may be established for data transmission by moving the male and female connectors together in respective directions of coupling, and wherein the contact pins are arranged such that cross-talk between the signals being transferred via the multiconnector connection is reduced.

The invention also relates to a multiconnector comprising a housing and contact pins whose one end extends through the bottom of the housing for mounting on an electrical circuit board, and wherein the contact pins are arranged such that cross-talk between the signals being transferred via the multiconnector is reduced, and wherein the housing has an opening for receiving a complementary multiconnector to provide electrical connections via coupling areas on the contact pins.

It is a common feature of such circuit boards or multiconnectors that they comprise a plurality of protruding contact pins whose location is of great importance to the cross-talk that may occur between the electrical signals which are to be transferred via the contact pins. Reference may be made e.g. to the prior art disclosed in British Patent Application 2 329 530. It is thus also known to provide a form of electrical compensation of the cross-talk by means of various techniques, but nevertheless the aim must be that the interfering cross-talk is as small as possible.

The object of the invention is to provide a solution where the cross-talk is smaller than has been achieved so far by the prior art.

This object is achieved in that the contact pins extend out from the circuit board substantially transversely to it and to the contact area in directions which are substantially indicated by the respective direction of coupling. Hereby, the distance which the signals have to travel along the contact pins is as short as possible in contrast e.g. to the technique where the contact pins first extend a distance in the direction of coupling and then turn and extend rearwards from the turning point.

Also in connection with a multiconnector according to the invention, the shortest possible signal distance is achieved in that the contact pins of the multiconnector extend from the bottom of the multiconnector via said contact areas toward the opening of the multiconnector.

In the preferred embodiment, the contact pins extend from the surface of the circuit board in two or more planes transversely to said surface from which the contact pins extend toward the contact area. This ensures not only the shortest signal distance, but also that the effective mutual spacing of the individual contact pins is as great as possible for further reduction of the cross-talk.

When the invention is performed in connection with a multiconnector, it may comprise a housing which is box-shaped, and it will be appreciated that the contact pins may extend out from any one of the sides of the housing, and that any other of the sides of the housing may have an opening for receiving a complementary multiconnector.

The invention will be explained more fully by the following description of some embodiments with reference to the drawing, in which

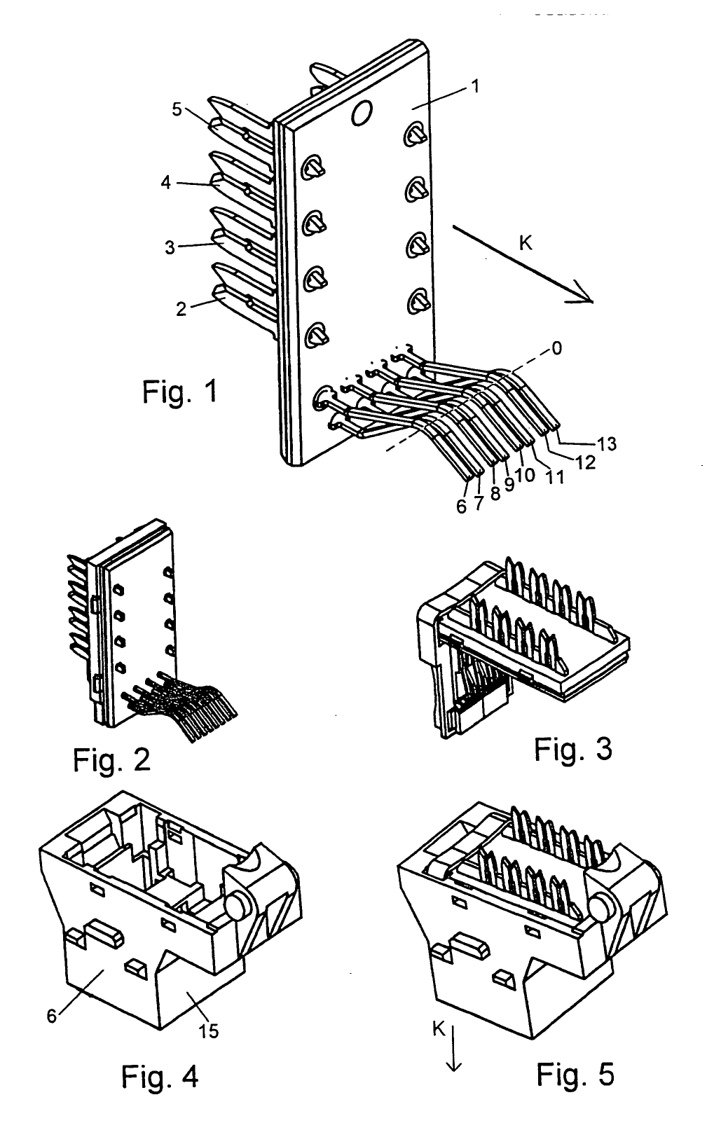

FIG. 1 shows an embodiment of a circuit board according to the invention,

FIG. 2 shows the same as FIG. 1, but in a scale which corresponds to FIGS. 3-5, where

FIG. 3 shows the circuit board of FIG. 2 arranged in a holder for support of the contact pins,

FIG. 4 shows a housing for the circuit board of FIGS. 2 and 3,

FIG. 5 shows the housing of FIG. 4 and the circuit board of FIG. 3 in an assembled position, while

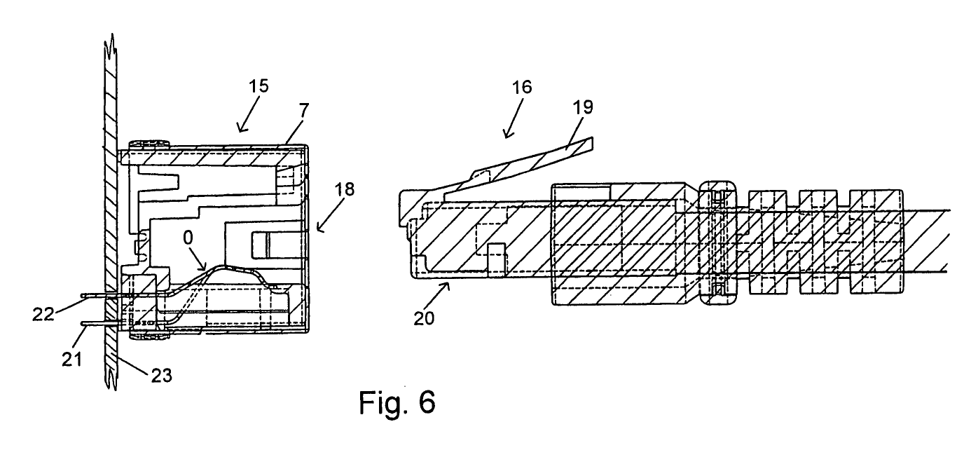

FIG. 6 shows an embodiment of a multiconnector according to the invention.

FIG. 1 shows a circuit board 1 having eight terminals, of which only the four terminals 2-5 can be seen. The terminals are connected to respective contact pins 6-13 preferably via circuit components which are adapted to counteract the cross-talk that occurs between the signals when they propagate between a contact area 0 and the respective terminals.

FIG. 3 shows the circuit board of FIGS. 1 and 2 inserted into a support 14 for the contact pins 6-13. The last-mentioned parts are configured to be pushed into a housing 15, which is shown in FIG. 4, whereby the multiconnector will look as shown in FIG. 5. Then, wires may be passed down into the terminals by means of a cover or in another manner, and the bottom of the housing 15 may have an opening for receiving a complementary connector which may provide an electrical connection along the contact area 0, which is shown in FIG. 1.

FIG. 5 moreover shows an arrow K which indicates the direction in which the housing 5 is to be moved toward a complementary connector to provide the above-mentioned electrical connection. The direction K is also drawn in FIG. 1, and it will thus be seen that the contact pins 6-13 extend out from one of the sides of the circuit 1 in directions which are substantially indicated by K. According to the invention, the contact pins extend substantially in this direction from the circuit board to the contact area 0. This provides the shortest possible distance which the signals travel along the contact pins. It moreover appears from FIG. 1 that the contact pins 6, 8, 10, 12 extend from a level on the circuit board 1 which is higher than the level from which the contact pins 7, 9, 11 and 13 extend. Moreover, the contact pins 6-13 are bent so that they extend substantially directly from the respective level to the contact area 0. The cross-talk between the contact pins is hereby reduced additionally. Finally, it will be seen in FIG. 1 that the outer ends of the contact pins 6-13 form an acute angle with the direction of coupling K, which is expedient for the joining of the circuit board according to the invention and a complementary connector.

FIG. 6 shows an embodiment of a multiconnector 15 according to the invention and a complementary connector 16.

The multiconnector 15 comprises a housing 17 with an opening 18 for receiving the complementary connector 16, which has a locking hook 19 for securing the connector 16 in the housing 7. The connector 16 has a plurality of contact areas located at 20, which are adapted to establish an electrical connection with respective contact pins in the housing 7, the last-mentioned contact pins being configured according to the invention, as will appear from the explanation above.

The multiconnector 15 is adapted to be secured to an electrical circuit board 23, as the contact pins, of which the pins 21 and 22 can be seen in FIG. 6, extend out through one of the sides of the housing 7 so that they may be secured to a circuit board. It will be seen in FIG. 6 that the contact pins 21 and 22 extend out from the solder area or the circuit board on which the housing 7 is secured, in the same manner as is explained in connection with FIG. 1. It will thus be seen clearly how the contact pin 22 extends from a higher level than the contact pin 21, when the contact pins extend obliquely upwards toward the contact area which is shown by the arrow 0. The configuration according to the invention means that the signals are to propagate the shortest possible distance along the contact pins, i.e. the shortest possible distance from the contact area 20 to the solder ends 21 and 22 is achieved when the connectors 15 and 16 are interconnected. It will be appreciated that the opening 18 must not necessarily be the opposite end of the housing 7 relative to the side where the contact pins 21 and 22 extend outside the housing.

1. An electrical circuit board having protruding contact pins which together form the contact area in a male connector or in a corresponding female connector, so that an electrical multiconnector connection may be established for data transmission by moving the male and female connectors together in respective directions of coupling, and wherein the contact pins are arranged such that cross-talk between the signals being transferred via the multiconnector connection is reduced, characterized in that the contact pins extend out from the circuit board substantially transversely to it and to the contact area in directions which are substantially indicated by the respective direction of coupling.

2. A circuit board according to claim 1, characterized in that the contact pins extend from the surface of the circuit board in two or more planes transversely to said surface from which the contact pins extend toward the contact area.

3. A circuit board according to claim 1 or 2, characterized in that the contact pins extend a distance past the contact area where they form an acute angle with the respective direction of coupling.

4. A multiconnector comprising a housing and contact pins, whose one end extends through the bottom of the housing for mounting on an electrical circuit board, and wherein the contact pins are arranged such that cross-talk between the signals being transferred via the multiconnector is reduced, and wherein the housing has an opening for receiving a complementary multiconnector to provide electrical connections via coupling areas on the contact pins, characterized in that the contact pins of the multiconnector extend from the bottom of the housing via said contact areas toward the opening of the housing.

5. A multiconnector according to claim 4, characterized in that the housing is box-shaped, and that the bottom and the opening of the housing are positioned on opposite sides of the housing.

6. A multiconnector according to claim 4, wherein the housing is box-shaped, characterized in that the bottom and the opening of the housing are positioned on adjacent sides of the housing.
